(19) United States
(12) Patent Application Publication
(10) Pub. No.: US 2008/0067783 A1
(43) Pub. Date: Mar. 20, 2008

(54) Hitch lock

(76) Inventor: Camille Rousseau, St-Jean-De-Matha (CA)

Correspondence Address: INVENTARIUM, Suite 1607, 4050 Rosemont Blvd, Montreal, QC, H1X 1M4, US

(21) Appl. No.: 11/525,142

(22) Filed: Sep. 20, 2006

(51) Int. Cl. B60D 1/60

(52) U.S. Cl. 280/507

(57) ABSTRACT

A hitch lock has a base component and a cover component overlapping the base component. The base component is mechanically fastened to the tow bar in a permanent fashion or can even extend integrally therefrom. A locking means passing through holes made into both the base component and the cover component. The locking means being in the guise of a pin passing through holes made into both the base component and the cover component. The pin being configured and sized at one end so as to not pass through the holes and configured at its opposite end so as to receive a locking means to lock the pin in place.

### FIELD OF THE INVENTION

The invention relates generally to hitching devices but more particularly to a locking cover to protect against tampering of a ball hitch and the hitch attached to it.

### BACKGROUND OF THE INVENTION

There are many cases of trailer theft and the simple lock placed on existing tow bars is insufficient. Therefore many boxlike devices have been developed over the years to protect the locking means of a tow bar which sits atop a ball hitch.

The problem with most of those devices is that they use standard padlocks which can be disabled or there are easy ways of ripping off the covers to gain access to the hitch. Since a lot of thefts occur when the trailer is not hitched to the towing vehicle, some thieves simply use the safety chains and attach them to their hitch so that even if the hitch is not attached to the hitch ball, they can do a quick escape with the trailer and then, at a later time, use a welding torch to remove the protective box.

There is therefore a need for a better anti theft device for trailers.

### SUMMARY OF THE INVENTION

In view of the foregoing disadvantages inherent in the known devices now present in the prior art, the present invention, which will be described subsequently in greater detail, is to provide objects and advantages which are:

To have detachable chains with attachments located inside the protective box.

To have a locking device that cannot be cut because it is integrated within the box.

To have a box that protects the hitch against tampering.

To attain these ends, the present invention generally comprises a base component and a cover component overlapping the base component. The base component is mechanically fastened to the tow bar in a permanent fashion or can even extend integrally therefrom. A locking means passing through holes made into both the base component and the cover component. The locking means being in the guise of a pin passing through holes made into both the base component and the cover component. The pin being configured and sized at one end so as to not pass through the holes and configured at its opposite end so as to receive a locking means to lock the pin in place.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Perspective view of the hitch lock over a tow bar.

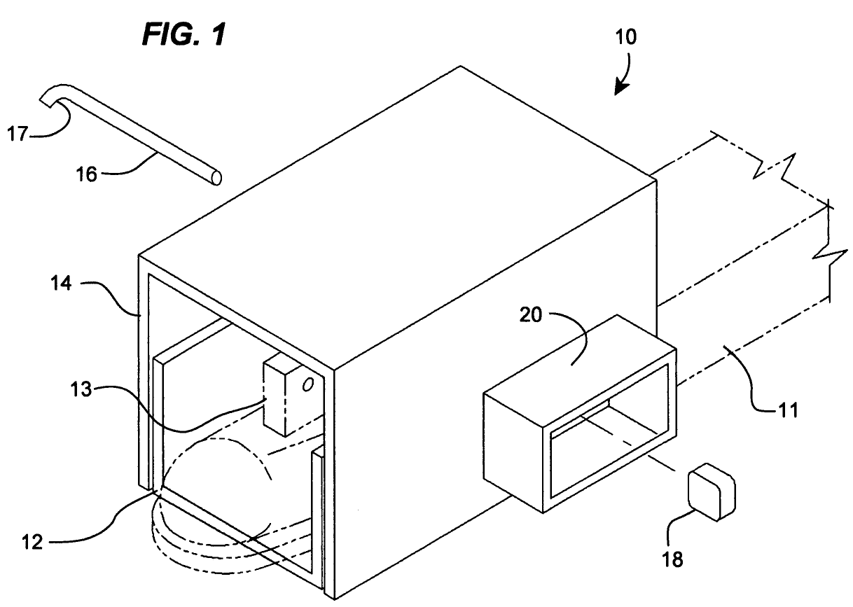

FIG. 2 Perspective view showing only the lower component on a tow bar.

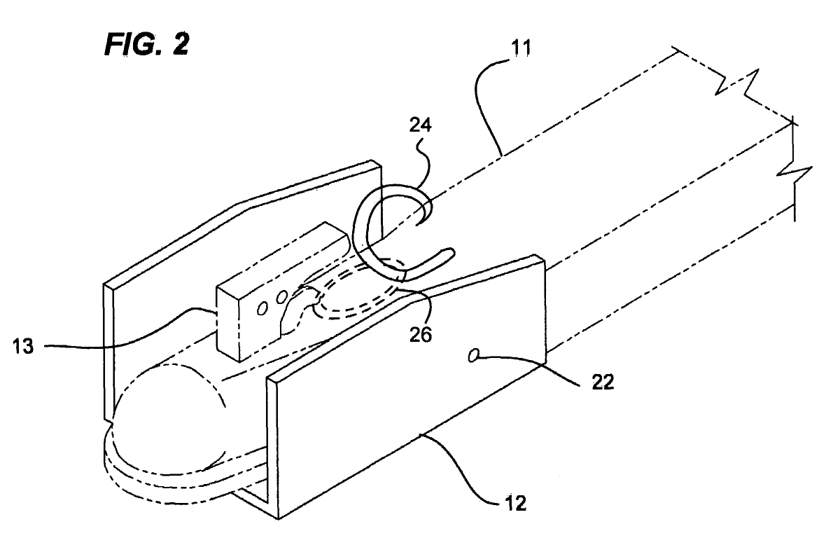

FIG. 3abc Top, front, and side views of the hitch lock over a tow bar, respectively.

### DETAILED DESCRIPTION

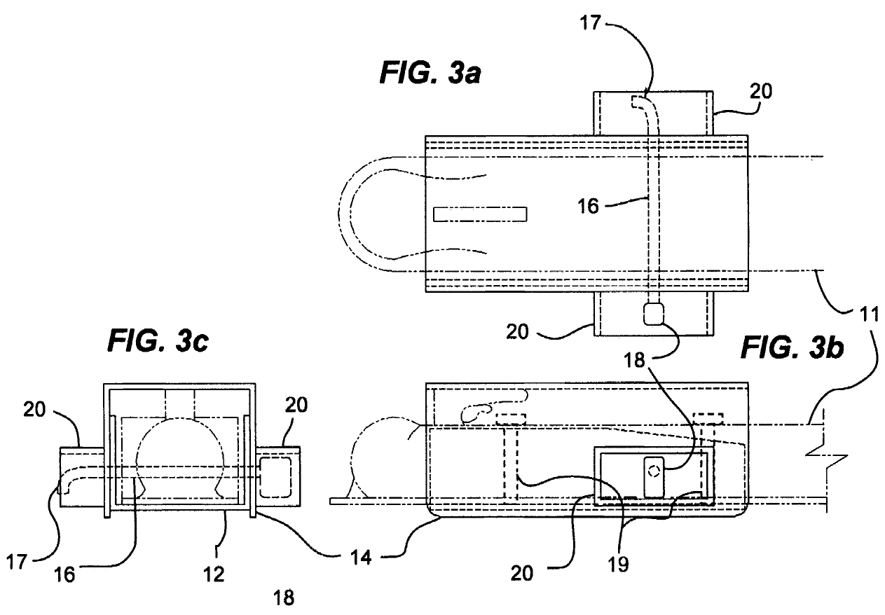

A hitch lock (10) used for covering a tow bar (11), more specifically the hitch (13) area, has a base component (12) and a cover component (14) overlapping the base component (12). The base component (12) is mechanically attached to the tow bar (11) in a permannet fashion, while the cover component (14) is either fully removable (as shown here) or hingedly attached (not shown) to either the base component (12) or the tow bar (11). The base component (12), besides being welded to the tow bar (11) could be mechnically fastened to the tow bar (11) by mechanical fasteners such as nuts and bolts (19) as illustrated in FIG. 3b for example. A locking means (16) in the guise of a pin (15) passes through holes (22) (only one shown) made into both the base component (12) and the cover component (14), thus locking them together. A <<J>> bend (17) at one end of the pin (16) blocks it from passing through, and a lock (18), at the opposite end locks the pin (16) and prevents its withdrawal. With the pin (16) inserted and locked, the cover component (14) is no longer removable and the locking means (13) cannot be tampered with. Besides the <<J>> bend, it should be obvious that other means such as a head at the end of the rod could save the same purpose, the <<J>> being shown here as an example.

The pin (16) and the lock (18) are known in the art and are currently used as replacement to a retaining pin (not shown) for locking a ball hitch (not shown) to the rest of a vehicle's hitching device (not shown). But when used with this hitch lock (10), the winglets (20) cover the lock (18) and the <<J>> bend (17) so as to make it inaccessible to hacksaws, cutters, welding torches, and any other means that could tamper with the lock (18).

The tow bar (11) can have at least one releasable attachment means (24) welded or otherwise mechanically attached to it and which allows passage for chains (26). These chains (26) are well known in the art and are used as safety backup. They are usually welded to the two bar (11). By thus making the chains (26) releasably attached from inside the hitch lock (10), they can be removed and stowed away but more importantly, a thief cannot attach chains to the releasable attachment means (24) when the cover component (14) is locked.

A typical method of use would be for a user to park his trailer (not shown), unlock the hitch lock (10), move the cover component (14), remove the chains (26) from both the releasable attachment means (24) and the vehicle's hitching device (not shown), disengage the hitch (13) and move the tow bar (11) away, reinstall the cover component (14) and lock it. The chains (26), still attached to the vehicle's hitching device (not shown) can then be removed and stowed away for later use.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A hitch lock used for covering the locking means of a tow bar comprising:
a base component and a cover component overlapping said base component;
a locking means passing through holes made into both said base component and said cover component.

2. A hitch lock as in claim 1 wherein:
said base component is mechanically attached to said tow bar in a permannet fashion.

3. A hitch lock as in claim 1 wherein:
said locking means being in the guise of a pin passing through holes made into both said base component and said cover component.

4. A hitch lock as in claim 3 wherein:
said pin being configured and sized at one end so as to not pass through said holes and configured at its opposite end so as to receive a locking means to lock said pin in place.

5. A hitch lock as in claim 1 wherein:
at least one releasable attachment means welded or otherwise mechanically attached to said tow bar at a location within said hitch lock and which allows for releasable attachment of at least one chain.

6. A hitch lock used for covering the locking means of a tow bar comprising:
a base component and a cover component overlapping said base component;
a locking means passing through holes made into both said base component and said cover component;
said base component is mechanically attached to said tow bar in a permannet fashion;
said locking means being in the guise of a pin passing through holes made into both said base component and said cover component; said pin being configured and sized at one end so as to not pass through said holes and configured at its opposite end so as to receive a locking means to lock said pin in place;
at least one releasable attachment means welded or otherwise mechanically attached to said tow bar at a location within said hitch lock and which allows for releasable attachment of at least one chain.

7. A hitch lock as in claim 1 having the following method of use:
parking a trailer, unlocking said hitch lock, moving said cover component;
disengaging said hitch and moving said tow bar away;
reinstalling said cover component and locking it.

8. A hitch lock as in claim 6 having the following method of use:
parking a trailer, unlocking said hitch lock, moving said cover component, removing chains from both said releasable attachment means and user's vehicle's hitching device; disengaging said hitch and moving said tow bar away; reinstalling said cover component and locking it.
